(19) United States
(12) Patent Application Publication
(10) Pub. No.: US 2007/0023118 A1
(43) Pub. Date: Feb. 1, 2007

(54) Building material

(75) Inventor: Antony Spielvogel, Melbourne (AU)

Correspondence Address: THE WEBB LAW FIRM, P.C., 700 KOPPERS BUILDING, 436 SEVENTH AVENUE, PITTSBURGH, PA, 15219, US

(73) Assignee: SB INTELLECTUAL PTY LTD, Melbourne (AU)

(21) Appl. No.: 11/194,912

(22) Filed: Aug. 1, 2005

(51) Int. Cl. B32B 27/10; B32B 29/00

(52) U.S. Cl. 156/46; 428/537.5; 428/513; 428/537.7

(57) ABSTRACT

A composite liner for plasterboard comprising a laminated sheet having outer plies of paper with an impervious, high tensile membrane sandwiched therebetween to impart impact, strength and water resistance. A plasterboard product comprising a core of gypsum covered on both sides, the cover of at least one side being a composite liner as described above.

### INTRODUCTION

This invention relates to building materials and in particular plasterboard or gypsum wallboard building materials.

### BACKGROUND OF THE INVENTION

The building industry uses both plasterboard, sometimes known as gypsum board, and fibre cement products for internal and external applications. Plasterboard is easier to use and cheaper than fibre cement but is less water resistant in wet area applications such as bathrooms, laundries, toilets and kitchens and eaves and less impact resistant in higher impact applications. Both products are used on a variety of internal and external walls for both domestic and industrial uses. The building panels can be used as barriers to reduce the transmission of sound and noise and are frequently used as easily decorated cladding for partitioning walls.

Fibre cement sheeting is heavier and more difficult to use but is often used in impact/high traffic applications. Fibre cement sheeting and plasterboard are products that usually compete with each other in various applications such as cladding in wet areas or impact/high traffic areas.

### SUMMARY OF THE INVENTION

This invention relates to a composite liner for use with plasterboard and a plasterboard product incorporating the liner.

According to one aspect of the present invention there is provided a composite liner for plasterboard comprising a laminated sheet having outer plies of paper with an impervious, high tensile membrane sandwiched therebetween to impart impact, strength and water resistance.

The term “impervious” as used herein is understood to mean having a resistance to the passage of liquid and vapour with the moisture vapour transmission rate (MVTR) being typically less than 25 g/m² per day at 38 degrees C. and 90% relative humidity measured as per ASTM E96 standard method or DIN 53122.

Preferably, the composite liner comprises three plies with the membrane sandwiched between two outer paper plies.

The membrane is preferably an alkylene (CO)polymer such as high density polyethylene or polypropylene, PVA or PET or any other suitable impervious material such as elastomers and plastics.

The paper that can be used for the outer paper plies includes a wide range of different papers but preferably embraces the papers that are usually used as the paper liner that is used with plasterboard, known as PBL. Plasterboard liner (PBL) is defined as a paper sheet with a relatively high tensile strength and a low level of water absorption in the grammage range of 100-300 g/m2. PBL has a gypsum side and an external side of which each has different physical characteristics. The gypsum side of the PBL has a high affinity for adhesion with the gypsum, which is achieved by chemical treatment or by sheet structure. The external side of the PBL is chemically treated on the surface and/or internally to provide a high level of liquid resistance with typical one minute water absorption (cobb) values of 10-40 g/m2 as per AS1301.411s standard test method. The external side surface is relatively smooth and flat which is suitable for painting and wall papering. A wide variety of papers can be used including kraft paper and light weight sack paper.

There have been a number of attempts to treat the paper that is used in the plasterboard industry, see for instance the disclosure of U.S. Pat. No. 4,020,237, British patent 1223651, and U.S. Pat. No. 6,523,324 all of which relate to treatments to paper that is used as the outer liner of plasterboard or gypsum board. It is understood that the paper can take many forms including virgin papers, recycled papers that are the combination of newspapers and magazines, and the combination of recycled papers that include recycled cardboard.

In accordance with a further aspect of the present invention there is provided a plasterboard product comprising a core of gypsum covered on both sides, the cover on at least one side being the composite liner described above.

Preferably, the cover on the other side of the core is plasterboard paper liner. Alternatively, the cover of the other side can also be the composite liner.

According to a still further aspect of the invention there is provided a method of manufacturing a plasterboard product comprising:

feeding a composite liner of the kind described above onto a forming plate;

applying a slurry of wet gypsum over the liner;

applying a back cover over the slurry;

forming and setting the slurry; cutting the set slurry into sheets; and

drying the sheets.

The method may also include the step of perforating the back cover to assist the drying of the sheets.

In accordance with a still further aspect of the present invention there is provided a plasterboard product manufactured by placing a slurry of gypsum between the composite liner and a paper liner to form a planar sheet, and drying the sheet.

### DESCRIPTION OF THE DRAWINGS

Embodiments of the present invention will now be described by way of example only with reference to the accompanying drawings in which:

FIG. 1 is a schematic illustration of a process for producing plasterboard, FIG. 2 is a more detailed view of the forming part of the process shown in FIG. 1, and FIG. 3 is a schematic illustration of a process for producing a composite liner for use with plasterboard.

### DESCRIPTION OF THE PREFERRED EMBODIMENTS

In its simplest form the invention relates to a composite liner that is impervious by forming a laminate of paper and an impervious membrane, preferably plastics. The composite liner is applied to one or both sides of gypsum core to produce a plasterboard product that is impervious and provides high resistance to liquid water and water vapour on at least one side so it can be used in wet areas and high impact areas, non-sag plasterboard for ceiling applications, impact/high traffic applications, bracing board and light weight board applications or similar application.

The impervious membrane which is usually plastics is a functional membrane which imparts greater tear strength, burst strength, tensile strength, water resistance to liquid water and water vapour, and impact resistance. Thus the membrane greatly enhances the end characteristics of the plasterboard product.

It is however understood that the product can have increased sophistication by use of other materials and additives to the gypsum slurry, special papers and specific plastics, elastomers for the composite liner and suitable additives and chemical treatment of the paper to provide specific characteristics. In this way it is envisaged that the product can be very versatile so that it can be used in a wide range of building applications in both domestic and industrial uses.

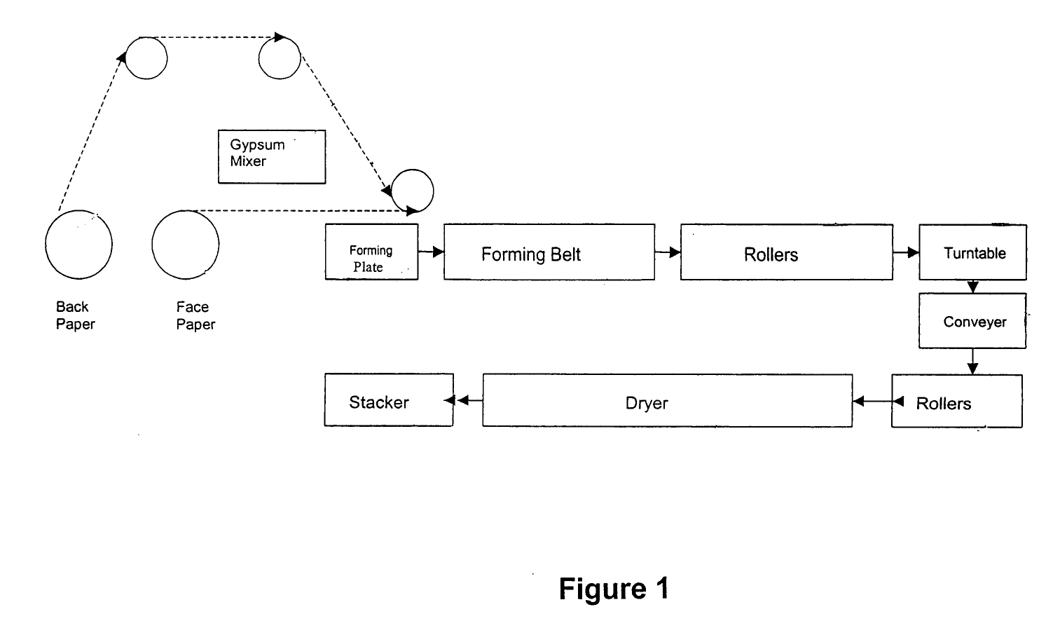

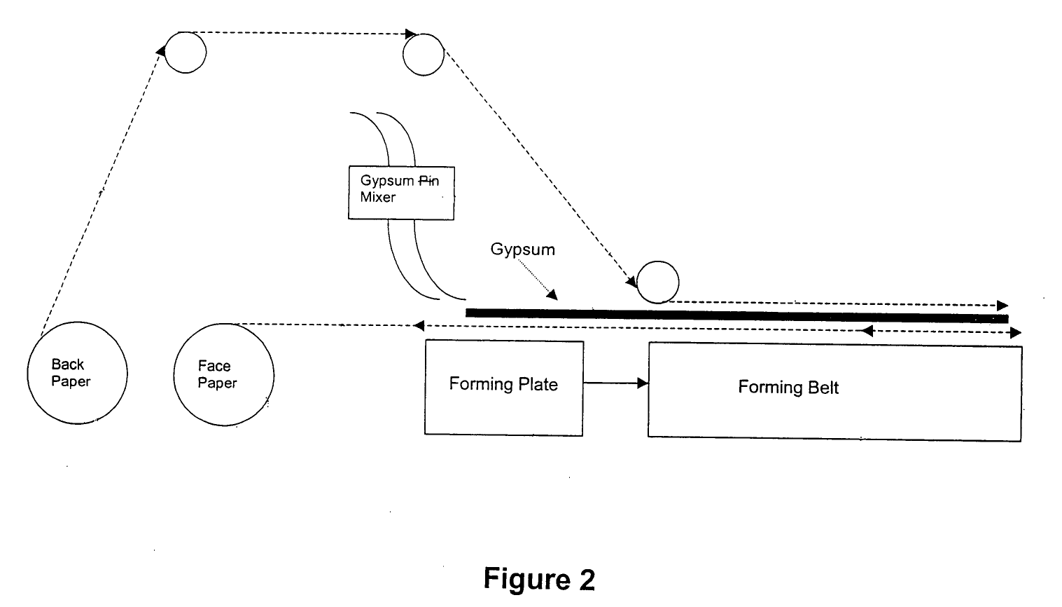

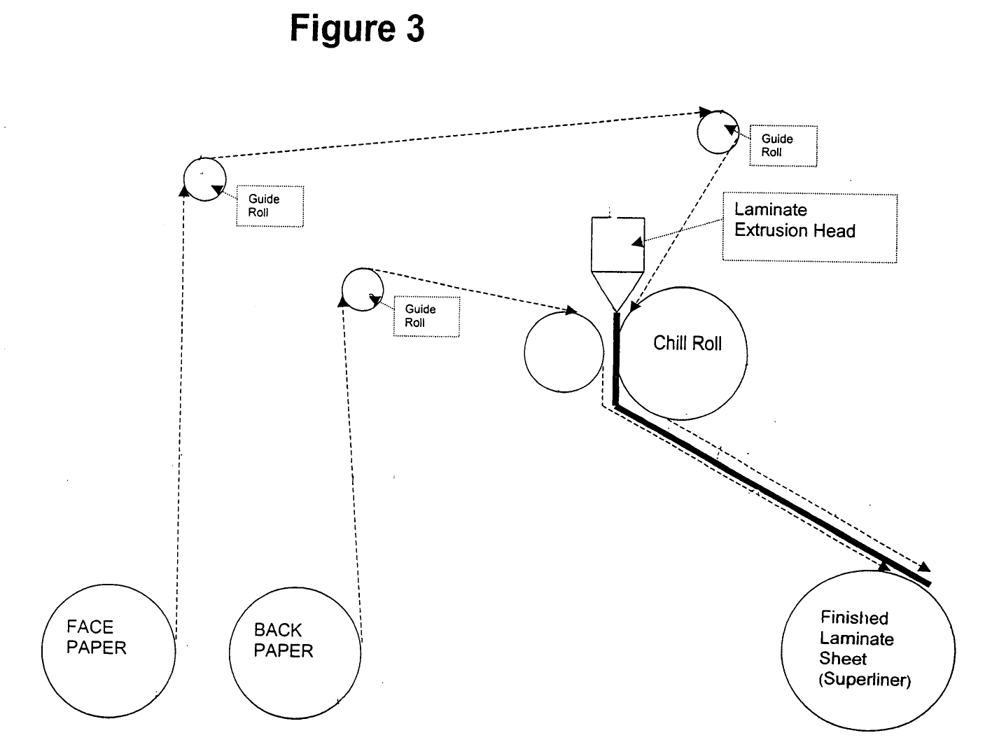

As shown in FIGS. 1 and 2, the traditional means of manufacturing plasterboard 50 is to draw face paper 51 over a forming table 52, spread a stucco slurry of gypsum, water and other additives 53 from a gypsum mixer 49 over the paper sheet 51 and then apply a back paper cover 54 over the slurry before it sets as it passes over a forming belt 55. The sandwich of paper and gypsum is carried along the forming belt 55 and transferred via rollers 56 to a cutting station (not shown) from which the cut sheets reach a turntable 57 which then presents the boards face up for drying. From the turntable 57 a conveyor 58 transfers the sheets to a multiple deck board drier 60 via rollers 59. Once dried the sheets are stacked in a stacker 61.

As shown in FIG. 3, the composite liner 10 is produced by extruding a plastics film 11 between two paper sheets 13, 14 as they come off paper rolls 15, 16 via guide rolls 17. The laminating process is akin to extrusion coating and allows the molten plastic 11 to be applied directly onto the moving web of the two paper sheets through the nip of the chill roll 18. An extruder 20 is mounted above the web and the plastic is forced onto the web through a slot type die 21. After the plastics is extruded onto the lower sheet of paper, the two webs are pressed together and then chilled curing the plastics to define the final sheet 10 that is wound onto a take up roll 25. Of the papers that can be used to make the composite liner, plasterboard liner paper is the preferred choice because this paper has been extensively used in the past to produce plasterboard. This paper can be used as the face paper 13 or the back paper 14.

Plasterboard liner paper usually has a gypsum side, that is the side that engages the gypsum and an external side. In the composite liner 10 described above only one side of one ply of paper will contact the gypsum whilst the other side will be in direct contact with the extruded plastics and the other ply will have an inner surface that is in contact with the extruded plastics and an outer surface that becomes the external side of the paper. It is known that the gypsum side of the paper may be treated during the paper manufacturing process with silicone, polysiloxane or other chemical agents which strengthen the adhesion between the gypsum and the paper. It is also usual for the external side to have a surface size applied to the paper. It is also known to have an internal size applied within the main body of the paper. The internal and surface sizing is applied in order to limit the rate of water penetration through the liner. Surface sizing is commonly used for surface strength and surface properties. The surface size may include oxidised starch or other sizing agents selected from the group consisting of wood resin or other chemical agents. Internal sizing may include sizing agents selected from the group consisting of alkenyl succinic anhydride, alkyl ketene dimer, mixtures thereof or other chemical agents. The sizing agents provide an external surface that can be painted, can support the adhesion of wall paper or assist in the application of tiles.

Although the preferred embodiment shows the application of two external paper plies 13, 14 to the membrane 11, it is understood that multiple plies could be envisaged. It is further understood that by the term “ply” it is envisaged multi-layered plies.

In the embodiment described above, the external plies of paper 13, 14 are, as mentioned earlier, preferably plasterboard liner ranging in weight from between 100 to 300 grams per m². If recycled or virgin based paper liners or combinations thereof are used it is likely that the weight would vary between 30 to 300 grams per m².

Various polymer options can be considered for the composite plasterboard liner (PBL). The selection of the membrane 11 is based on technical requirements and cost effectiveness/commercial considerations.

The membrane 11 must give good chemical or physical bonds with the PBL, must provide a very good moisture barrier, have good rigidity, good tensile strength, a high temperature resistance and be cost effective. Also the membrane needs to maintain its physical structure and properties after heat and moisture exposure for up to 45 minutes.

The preferred membranes 11 are high density polyethylenes and homopolymer polypropylenes. However membranes 11 could also be any other synthetic and/or organic membranes such as PVA, PET, elastomers or other plastics.

Typically the membranes 11 have:
High crystallinity
Melting points in the range of 110 to 250 degrees C.
Vicat Softening points in the range of 100 to 240 degrees C.
Weight of resin in the range of 10 to 45 gsm
Strong impact (puncture) resistance (i.e. with Notched Charpy impact strength at 23 degrees C. values of in excess of 2.5KJ/m²).
Natural high moisture barrier with MVTR less than 25 g/m² per day at 38 degrees C. and 90% relative humidity
Ability to maintain physical structure and properties after heat and moisture exposure for up to 45 minutes

As mentioned above, the composite liner is specifically designed for use with plasterboard and in FIG. 2 there is a schematic illustration of a process line for manufacturing plasterboard in which the composite liner is applied to at least one side of the board.

In the manufacturing process of this invention, the conventional plasterboard manufacturing process of FIG. 1 is adopted except that the back surface 54 is conventional plasterboard liner paper and this is the surface that would face into a wall or ceiling cavity and will be hidden from view. The other external surface, that is the face surface of the plasterboard is lined with the composite liner 10 which would face into a room and accordingly provide the visible surface with all the functional properties referred to earlier. In this embodiment, because the composite liner 10 is impervious and provides high resistance to liquid water and water vapour, it is not possible for the gypsum core 53 to dry through the composite liner and thus the drying has to take place through the plasterboard liner 54 that is on the other face of the board. If the rate of drying becomes an issue, it is understood that the drying process maybe assisted by positioning small holes, that is holes of between 0.1 and 1 mm diameter randomly spaced in the plasterboard liner on the back of the plasterboard product. Any further issues with overall drying rates may also be overcome by reducing the unit throughput of the manufacturing process via adjustments to the speed or temperature of the drying process.

In another embodiment, the plasterboard product has the composite liner on both sides. Since both composite liners are impervious to water there is then a problem in drying the slurry of gypsum. The plasterboard manufacturing process may need to be modified to allow drying of the gypsum core. Adjustments may include having random pinholes in the side of the board to allow the release of the water during the drying process. Another means of overcoming this problem is to first produce the gypsum sheet covered with a thin layer of paper on either side and then adhesively attach the composite liner to each side of the pre-prepared sheet.

In the first embodiment where the back surface is covered with plasterboard liner paper it is understood that a variety of other paper liners could be used instead of the more conventional plasterboard liner paper. It is further understood that the gypsum core could contain a variety of additives specifically included to alter the characteristics of the end product.

The plasterboard product incorporating the composite liner described above has a number of advantages. The conventional products include plasterboard specifically designed for wet areas. This product has water resistant additives that are added to the gypsum core and the plasterboard product is popular from the fixing/installation perspective because it is easier to handle, cut, lighter, and of useful thickness.

The other known option is the use of fibre cement sheet which has excellent water resistant capabilities and is significantly stronger than plasterboard. However, the disadvantage of fibre cement is that it is heavy, very difficult to cut and more expensive to install often requiring an additional trades person. Fibre cement sheets also come in different thicknesses to plasterboard and cause matching problems where the fibre cement sheet is used together with plasterboard. In contrast, the product described herein compared with the wet area plasterboard, non-sag plasterboard for ceiling applications, impact/high traffic applications, brace board and lighter weight board applications etc has:
a.) superior liquid water and water vapour resistant capabilities due to the membrane,
b.) is significantly stronger than plasterboard,
c.) has the same thickness as conventional plasterboard,
d.) has superior impact resistance,
e.) has no obvious disadvantages compared with plasterboard,
f.) can be manufactured by plasterboard producers on existing equipment without the installation of expensive equipment, and
g.) allows for light weighting of traditional board thicknesses/densities.

When the plasterboard product described herein is compared with fibre cement, fibre cement in particular wet area applications, impact/high traffic areas and bracing material etc., it has the advantages that:
a.) it is significantly less in weight,
b.) it is much easier to cut and does not require sawing as is the case with fibre cement,
c.) is less expensive to install,
d.) does not require an additional trades person,
e.) the logistics in use are more efficient,
f.) the product has similar water resistant capabilities but the impervious membrane provides a minimal penetration into the gypsum core,
g.) the product is paintable, and
h.) it has a lower cost of manufacture and installation, hence it is a more economical product.

The product provides a very versatile and efficient product that is an alternative for plasterboard and fibre cement sheeting in the applications below.

It is envisaged that the product will be aimed at but not limited to:

wet area wall applications, such as bathrooms, laundries, toilets, kitchens, garage ceilings, verandah ceilings, eave linings;

impact resistant wallboard for hallways, playrooms, hospitals, and commercial offices;

ancillary purposes such as bracing;

lighter weighted plasterboard applications; and

ceiling and non-sag ceiling applications.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Having now described my invention, what I claim is:

1. A composite liner for plasterboard comprising a laminated sheet having outer plies of paper with an impervious, high tensile membrane sandwiched therebetween to impart impact, strength and water resistance.

2. The composite liner according to claim 1 wherein the laminate sheet comprises three plies with the membrane sandwiched between the two outer paper plies.

3. The composite liner according to claim 1 wherein the membrane is an alkylene (Co)polymer.

4. The composite liner according to claim 3 wherein the membrane is high density polyethylene.

5. The composite liner according to claim 1 wherein the membrane is homopolymer polypropylene.

6. The composite liner according to claim 1 wherein the membrane is synthetic and/or organic material such as PVA, PET, elastomers or plastics.

7. The composite liner according to claim 1 wherein at least one of the outer paper plies is plasterboard liner paper.

8. The composite liner according to claim 1 wherein the outer paper plies are kraft paper or lightweight sack paper.

9. A plasterboard product comprising a core of gypsum covered on both sides, the cover of at least one side being a composite liner according to claim 1.

10. The plasterboard product according to claim 9 wherein cover of the other side of the core is plasterboard paper liner.

11. The plasterboard product according to claim 9 wherein the cover of the other side of the core is the composite liner.

12. A method of manufacturing a plasterboard product comprising:
feeding the composite liner of claim 1 onto a forming means;
applying a slurry of wet gypsum over the liner;
applying a back cover over the slurry;
forming and setting the slurry; cutting the set slurry into sheets; and
drying the sheets.

13. The method according to claim 12 comprising the step of perforating the back cover to assist the drying of the sheets.

14. A plasterboard product manufactured by placing a slurry of gypsum between a composite liner according to claim 1 and a paper liner to form a planar sheet, and drying the sheet.
